(19) United States
(12) Patent Application Publication
(10) Pub. No.: US 2011/0150290 A1
(43) Pub. Date: Jun. 23, 2011

(54) METHOD AND APPARATUS FOR PREDICTING INFORMATION ABOUT TREES IN IMAGES

(75) Inventor: Jeffrey J. Welty, Tacoma, WA (US)

(73) Assignee: WEYERHAEUSER NR COMPANY, Federal Way, WA (US)

(21) Appl. No.: 12/645,325

(22) Filed: Dec. 22, 2009

(51) Int. Cl. G06K 9/62

(52) U.S. Cl. 382/110

(57) ABSTRACT

A system for predicting a metric for trees in a forest area analyzes a spatial variation in pixel intensities in or more spectral bands in an image of the trees. The variation in pixel intensities is related to the predicted metric for the trees by a relationship determined from images of trees having ground truth data. In one embodiment, a linear regression determines the relationship between the spatial variation in pixel intensities and the metric. In one embodiment, the spatial variation in the pixel intensities in an image is determined in a frequency domain with a two-dimensional Fourier transform of the pixel intensity values.

### BACKGROUND

In forest management, it is important to know information about the trees in a forest area. Such information can include the species of trees in the forest, their spacing, age, diameter, health, etc. This information is useful for revenue prediction, active management planning (such as selective thinning, fertilizing etc.), determining where to transport logs or how to equip a sawmill to process the logs and for other uses. While it is possible to inventory a forest area using statistical surveying techniques, it is becoming increasingly cost prohibitive to send survey crews into remote forest areas to obtain the survey data. As a result, remote sensing is becoming increasingly used as a substitute for physically surveying a forest area. Remote sensing typically involves the use of aerial photography or satellite imagery to produce images of the forest. The images are then analyzed by hand or with a computer to obtain information about the trees in the forest.

The most common way of analyzing an image of the forest in order to identify a particular species of tree is to analyze the brightness of the leaves or needles of the trees in one or more ranges of wavelengths or spectral bands. Certain species of trees have a characteristic spectral reflectivity that can be used to differentiate one species from another. While this method can work to distinguish between broad classes of trees such as between hardwoods and conifers, the technique often cannot make finer distinctions. For example, spectral reflectance alone is not very accurate in distinguishing between different types of conifers such as Western Hemlock and Douglas Fir. Given these limitations, there is a need for an improved technique of analyzing images of forest lands to predict information about the trees in the images.

### SUMMARY

The technology disclosed herein relates to a method of predicting information about trees based on a spatial variation of pixel intensities within an image of the forest where the area imaged by each pixel is less than the expected crown size of the trees in the forest. In one embodiment, a number of training images of forest areas are obtained for which ground truth data for one or more measurement metrics of the trees in the forest are known. The training images of the forest area are analyzed to determine a measure of the spatial variation in the intensity of the pixel data in one or more spectral bands for the images. The determined spatial variations are correlated with the verified metrics for the trees in the training images to determine a relationship between the spatial variations and the particular metric. Once a relationship has been determined, the relationship is used to predict values of the metric for trees in other forest areas.

In one embodiment, the spatial variation of the pixel intensities is determined by analyzing pixel intensity data in a frequency domain. In one embodiment, a two-dimensional fast Fourier transform (FFT) is computed on the pixel intensity data for an area of an image. Parameters from an FFT output matrix are used to quantify the spatial variation of the pixel intensities and to predict a value for the correlated metric for the trees in the image using a relationship determined from the ground truth data.

In one embodiment, the average power of the frequency components and the standard deviation of the powers of the frequency components in rings of cells surrounding an average pixel intensity value in the FFT output matrix are used to quantify the spatial variation in pixel intensities.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 represents a forest area containing a number of different tree species;

FIG. 2 illustrates a representative computer system for predicting a metric of trees in an image from a spatial variation of pixel intensities in accordance with an embodiment of the disclosed technology;

FIG. 3 illustrates a portion of a two-dimensional FFT output matrix for use in an embodiment of the disclosed technology;

FIG. 4 is a flowchart of a number of steps performed to analyze a set of training images in accordance with an embodiment of the disclosed technology; and

FIG. 5 is a flowchart of a number of steps performed to predict a metric for trees in a forest area based on a determined spatial variation of pixel intensities in an image of the forest area in accordance with an embodiment of the disclosed technology.

### DETAILED DESCRIPTION

As indicate above, the technology disclosed herein relates to a method of operating a computer system to predict a metric for trees in a forest area from a corresponding image of the trees. In one disclosed embodiment, the metric to be determined is the percentage of a particular species of tree in a forest area. However, the metric may be other information such the number of trees of a particular species in the forest area, the average age of the trees, the average diameter of the trees or other information that is capable of being verified with ground truth data.

FIG. 1 represents a forest area 50 that contains a number of different tree species that are labeled as Western Hemlock (H), Douglas Fir (D) and “other” (O). In some instances a forester would like to know how what percentage of trees in the forest area 50 are a particular species. In the example shown, the forest area 50 has 43% Western Hemlock and 36% Douglas Fir. As will be explained in further detail below, the technology described herein is used to predict the percentage of species metric for the forest area 50 by analyzing a spatial variation in pixel intensities for an image of the forest area and using a determined relationship between the spatial variation in pixel intensities and the percentage of a species of tree in the forest.

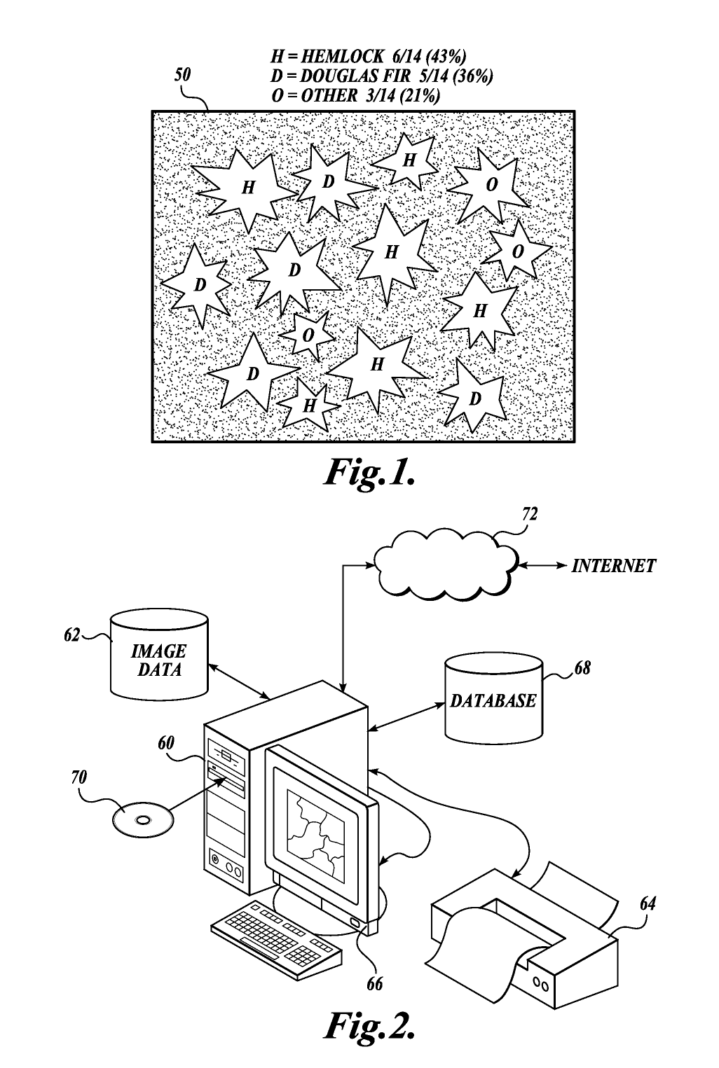

FIG. 2 illustrates a computer system that can be used to predict a value for a metric for trees in a forest from an image of a forest area. The system includes a stand-alone or networked computer 60 including one or more processors that are programmed to execute a sequence of instructions as will be described below. The computer 60 receives and stores one or more images of a forest area on a computer storage media such as a hard drive 62, CD-ROM, DVD, flash memory etc. Alternatively, the images of the forest area can be received via a communication link 72 such as a local or wide area network connected to the Internet. The computer 60 analyzes an image of the forest area to predict a value for a metric of the trees in the image using a relationship that is determined from a number of training images as will be described below. Once the metric for the trees in the forest area has been predicted from an analysis of the image of the forest, the predicted metric can be printed on a printer 64, displayed on a computer monitor 66 or stored in a database 68 on a computer readable media (hard drive, flash drive, CD-ROM, DVD etc.) Alternatively the predicted metric can be sent to one or more remote computers via the communication link 72. The instructions for operating the one or more processors in the computer 60 to implement the techniques described below are stored on a computer readable storage media 70 (CD, DVD, hard drive, flash memory etc) or can be downloaded from a remote computer system via the communication link 72.

As indicated above, the disclosed technology analyzes a spatial variation in pixel intensities within an image of a forest to predict a metric for the trees in the image. The spatial variation captures the higher intensity pixels caused by brighter reflections from the leaves or needles in the tree canopy as well as the darker spots where there are no leaves or needles or where the leaves and needles are in shadow. The spatial pattern of lighter and darker areas in the canopy provide information that is related to the metric being predicted.

In one embodiment of the disclosed technology, the spatial variations in pixel intensities within an image are measured by converting the pixel intensities of the image into a corresponding frequency domain. In one particular embodiment, the pixels are converted into the frequency domain using a two-dimensional FFT or wavelet analysis. To convert the pixel intensities into the frequency domain, a pixel block from the image is selected. Preferably the pixel block is square with a number of pixels that is evenly divisible by 2 e.g. 16×16, 32×32, 64×64 etc. The area imaged by each pixel and the number of pixels in the pixel block is a selected to be able to detect small variations within the canopy while not requiring too long to analyze all the pixels within the images of the forest. In one embodiment, each pixel images an area of approximately 1 meter square and the pixel block has 32 by 32 pixels.

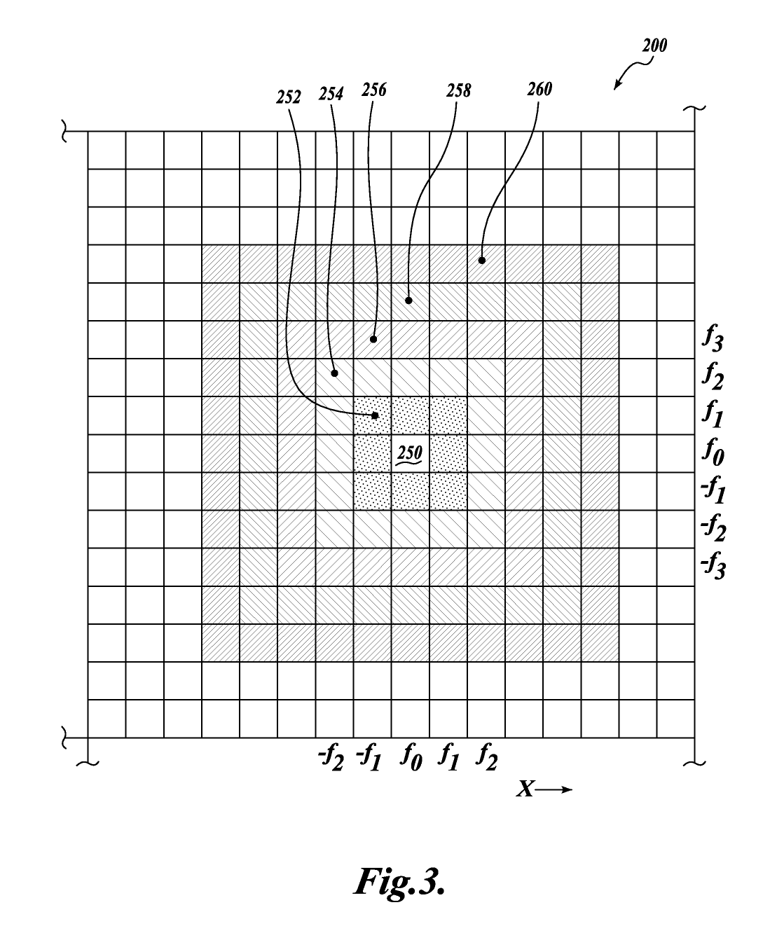

FIG. 3 illustrates a two-dimensional FFT output matrix 200. As will be understood by those of skill in the art of signal processing, the output matrix 200 contains a number of cells computed for a pixel block where each cell contains the power of a pair of frequency components in the X and Y directions. In one embodiment, the output matrix 200 is re-arranged such that a center cell 250 of the FFT output matrix 200 stores the average value of the pixel intensities in the pixel block. Surrounding the center cell 250 are a number of rings 252, 254, 256, 258, 260 etc. each having a number of cells that store values for the power of a pair of frequency components in the X and Y directions. In one embodiment, the spatial variation in the intensity of the pixels in a pixel block is quantified by the average power of the frequency components in each of the rings surrounding the center cell 250 and the standard deviation of the powers for the cells in each of the rings.

In the example shown, the FFT output matrix 200 is calculated from a 16×16 pixel block and has 8 rings surrounding the center cell 250. The average power of the frequency components in the cells of each ring are calculated as P1-P8. That is, P1 is the average power of the frequency components in the ring 252. P2 is the average power of the frequency components in the cells of the ring 254. P3 is the average power of the frequency components in the cells of the ring 256 etc. The standard deviations for the powers of the frequency components in the cells of each ring are calculated as SD1-SD8 in a similar manner i.e. SD1 is the standard deviation of the powers in the cells of ring 252, SD2 is the standard deviation of the powers in the cells of ring 254 etc. In this embodiment, each FFT output matrix is used to calculate 16 variables that vary with the spatial variation of the pixel intensities of the corresponding pixel block.

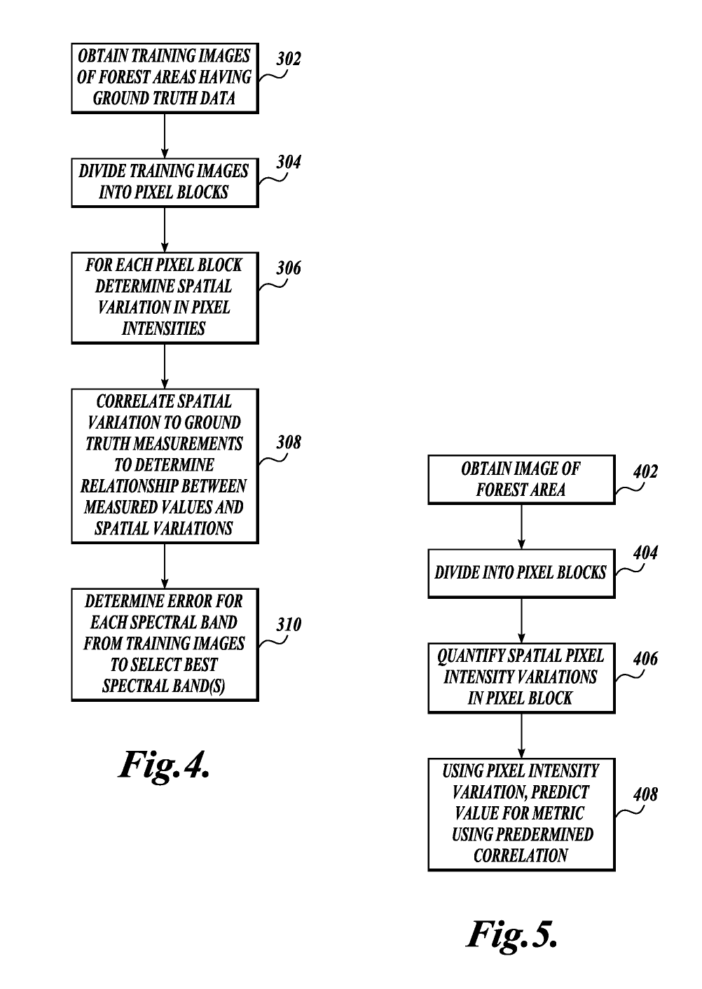

FIG. 4 shows a series of steps performed by the computer system to predict a metric for trees in a forest area from the spatial variation of the pixel intensities in a corresponding image of the forest in accordance with one embodiment of the disclosed technology. Beginning at 302, the computer system obtains a number of training images of forest areas that have been physically surveyed and have ground truth or verified measurements associated with them. Such ground truth data can include measurements of the number of trees of a particular species in the area of the forest, the percentage of trees that are a particular species, the diameters of the trees, the heights of the trees, the ages of the trees or other statistics that are of interest to a forester. The training images are divided into pixel blocks at 304. At 306, the pixel blocks are analyzed to determine a measure of the spatial variation of the pixel intensities within each pixel block. In one embodiment, the spatial variation is quantified from the average power of the frequency components in the cells of each ring surrounding the average intensity value in the FFT output matrix and by the standard deviation of the power of the frequency components for the cells in each ring.

At 308, the computer system performs a statistical correlation between the measure of the spatial variation in pixel intensity values as determined by the quantities P1-P8 and SD1-SD8 and measurements taken from the trees that are imaged by each pixel block. For example, a correlation can be made between the values P1-P8 and SD1-SD8 computed from the FFT output matrix for each pixel block and the measured percentage of a particular species of tree in the areas corresponding to each pixel block.

In one embodiment, the correlation is made by computing a least squares linear regression of the measured ground truth metrics from the areas corresponding to the pixel blocks in each of the training images and the 16 variables determined from the FFT output matrices that quantify the spatial variations in pixel intensities from the pixel blocks. As will be understood by those of skill in the art, the result of the linear regression is a set of 16 coefficients, each of which corresponds to one of the 16 variables that quantify the spatial variation in pixel intensity values. The sum of the 16 variables and their corresponding coefficients determined from the regression predict a value for a metric for the trees in the image.

In one embodiment, each training image has pixel data for a number of spectral bands e.g. green, red, infrared etc. The spatial variation in pixel intensities for each spectral band is analyzed and used to compute a set of corresponding coefficients using a regression analysis. At 310, an error, such as a least squares error, can be computed for the coefficients determined for each spectral band in order to select which spectral band correlates best with the particular metric in question. As will be appreciated, some metrics (e.g. tree species) may be better predicted using pixel intensities in one spectral band while other metrics (e.g. tree age) may be better predicted using pixel intensities in another spectral band. In another embodiment, the variables from two or more spectral bands may be used in determining the relationship between the measurement metric and the variation in pixel intensities from the images. For example, if two more spectral bands are used, then the linear regression analysis can be performed with the variables determined from the FFT's computed from the images in each spectral band.

As shown in FIG. 5, once the computer has determined a relationship, such as the value of the linear regression coefficients, between the spatial variations of the pixel intensities in the training images and a verified measurements for the trees in the images, the relationship is then used to predict the metric for trees in other images.

To predict a metric for trees in an area of a forest, an image of the forest area is obtained at 402. The image is divided into one or more pixel blocks at 404 and the spatial variation of the pixel intensities using the spectral band or bands that best correlated with the metric to be predicted is determined at 406. At 408, a predicted value for a metric (species, age, diameter etc.) for the trees imaged by the pixel block is predicted using the relationship previously determined from the training images.

While illustrative embodiments have been illustrated and described, it will be appreciated that various changes can be made therein without departing from the scope of the invention. For example, other techniques besides a two-dimensional Fourier transform could be used to quantify the spatial variation in pixel intensities. Furthermore, pattern analyses such as cluster analyses or other two-dimensional image processing techniques could be used to quantify the spatial variation in the pixel intensities in an image. Similarly, other measurements from the FFT output matrix such as the standard deviation alone or the average power alone could be used in the correlation. Therefore, the scope of the invention is to be determined from the following claims and equivalents thereof.

The embodiments of the invention in which an exclusive property or privilege is claimed are defined as follows:

1. A method of using a computer to predict information about trees from an image of the trees, comprising:
storing an image of the trees into a memory of the computer, wherein the image has a number of pixels having varying pixel intensity values in one or more spectral bands;
using the computer to quantify a spatial variation of the pixel intensity values in the image; and
using the computer to predict information about trees in the image based on a predetermined relationship that relates a spatial variation in pixel intensity values to the information to be predicted.

2. The method of claim 1, wherein the relationship uses the spatial variation of pixel intensity values in a single spectral band to predict information about the trees in the image.

3. The method of claim 1, wherein the relationship uses the spatial variation of pixel intensity values in two or more spectral bands to predict information about the trees in the image.

4. The method of claim 1, wherein the computer is programmed to quantify the spatial variation of pixel intensity values by converting the pixel intensities in one or more of the spectral bands of the image into a frequency domain.

5. The method of claim 4, wherein the computer is programmed to quantify the spatial variation of the pixel intensity values by calculating an average power of frequency components in cells of a number of rings that surround an average pixel intensity value in a fast Fourier transform (FFT) output matrix for one or more of the spectral bands.

6. The method of claim 4, wherein the computer is programmed to quantify the spatial variation of the pixel intensity values by calculating a standard deviation in a power of the frequency components in cells of a number of rings that surround an average pixel intensity value in a fast Fourier transform (FFT) output matrix for one or more of the spectral bands.

7. The method of claim 1, wherein the computer is programmed to determine a relationship between the quantified spatial variation in pixel intensity values in one or more of the spectral bands and the predicted information based on a correlation between measured information of trees and the quantified spatial variation of pixel intensity values in images of the trees.

8. The method of claim 1, wherein each pixel images an area that is smaller than the expected crown size of the trees in the image.

9. The method of claim 8, wherein each pixel images an area of approximately 1 meter square.

10. A system for predicting information about trees in a forest from an image of the trees comprising:
a memory that is configured to store a sequence of programmed instructions;
a processor for executing the programmed instructions, wherein the instructions cause the processor to:
store an image of the trees into a memory, wherein the image includes a number of pixels having varying pixel intensity values in one or more spectral bands;
quantify a spatial variation of the pixel intensity values in the image for one or more of the spectral bands; and
predict information about trees in the image based on a predetermined relationship that relates a spatial variation in pixel intensity values to the information to be predicted.

11. The system of claim 10, wherein the instructions when executed cause the processor to quantify the spatial variation of pixel intensity values by converting the pixel intensities of the image for one or more of the spectral bands into a frequency domain.

12. The system of claim 11, wherein the instructions when executed cause the processor to quantify the spatial variation of the pixel intensity values by calculating an average power of frequency components in cells of a number of rings that surround an average pixel intensity value in a fast Fourier transform (FFT) output matrix for one or more of the spectral bands.

13. The system of claim 11, wherein the instructions when executed cause the processor to quantify the spatial variation of the pixel intensity values by calculating a standard deviation in a power of the frequency components in cells of a number of rings that surround an average pixel intensity value in a fast Fourier transform (FFT) output matrix for one or more of the spectral bands.

14. The system of claim 10, wherein the instructions when executed cause the processor to determine a relationship between the quantified spatial variation in pixel intensity values in one or more of the spectral bands and the predicted information based on a correlation between measured information of trees and the quantified spatial variation of pixel intensity values in one or more of the spectral bands in images of the trees.

15. A computer storage media containing a sequence of program instructions that are executable by a processor to predict information about trees in a forest from an image of the trees, wherein the instructions, when executed, cause a processor to:
receive an image of the trees into a memory, wherein the image includes a number of pixels having varying pixel intensity values for one or more spectral bands;
quantify a spatial variation of the pixel intensity values in the image for one or more of the spectral bands; and
predict information about trees in the image based on a predetermined relationship that relates a spatial variation in pixel intensity values to the information to be predicted.

16. The computer storage media of claim 15, wherein the instructions, when executed, cause the processor to quantify the spatial variation of pixel intensity values by converting the pixel intensities of the image for one or more of the spectral bands into a frequency domain.

17. The computer storage media of claim 16, wherein the instructions when executed, cause the processor to quantify the spatial variation of the pixel intensity values by calculating an average power of frequency components in cells of a number of rings that surround an average pixel intensity value in a fast Fourier transform (FFT) output matrix for one or more of the spectral bands.

18. The computer storage media of claim 16, wherein the instructions, when executed, cause the processor to quantify the spatial variation of the pixel intensity values by calculating a standard deviation in a power of the frequency components in cells of a number of rings that surround an average pixel intensity value in a fast Fourier transform (FFT) output matrix for one or more of the spectral bands.

19. The computer storage media of claim 15, wherein the instructions when executed, cause the processor to quantify the determine a relationship between the quantified spatial variation in pixel intensity values for one or more of the spectral bands and the predicted information based on a correlation between measured information of trees and the quantified spatial variation of pixel intensity values for one or more of the spectral bands in images of the trees.
